(19) United States
(12) Patent Application Publication
(10) Pub. No.: US 2025/0308144 A1
(43) Pub. Date: Oct. 2, 2025

(54) THREE DIMENSIONAL GAUSSIAN SPLATTING WITH EXACT PERSPECTIVE TRANSFORMATION

(71) Applicant: NVIDIA Corp., Santa Clara, CA (US)

(72) Inventors: Cheng Sun, Taoyuan City (TW); Jaesung Choe, Taipei City (TW); Yu-Chiang Wang, Neihu District (TW)

(73) Assignee: NVIDIA Corp., Santa Clara, CA (US)

(21) Appl. No.: 19/094,672

(22) Filed: Mar. 28, 2025

Related U.S. Application Data
(60) Provisional application No. 63/572,848, filed on Apr. 1, 2024.

(51) Int. Cl. G06T 15/20; G06T 7/50; G06T 7/73; G06T 15/00; G06T 15/06

(52) U.S. Cl. CPC G06T 15/205; G06T 7/50; G06T 7/73; G06T 15/005; G06T 15/06; G06T 2200/04; G06T 2207/20081; G06T 2207/30244

(57) ABSTRACT

Three-dimensional Gaussian splatting mechanisms that initialize a set of 3D Gaussian distributions, un-project pixels from two-dimensional (2D) planes to 3D space by applying queries to the 3D Gaussians at expected un-projected ray depth positions, and splat the 3D Gaussian distributions on the 2D planes based on the expected un-projected ray depth positions.

### CROSS-REFERENCE TO RELATED APPLICATIONS

This application claims priority and benefit under 35 U.S.C. 119 (e) to U.S. Application Ser. No. 63/572,848, “3DGS-Expert: 3D Gaussian Splatting with Exact Perspective Transformation”, filed on Apr. 1, 2024, the contents of which are incorporated herein by reference in their entirety.

### BACKGROUND

Three-dimensional (3D) Gaussian splatting (3DGS) is a mechanism for composing digital scenes using 3D splats that follow a Gaussian distribution. 3DGS mechanisms may be utilized to construct a representation of a 3D scene from 2D images taken from different viewpoints. Each Gaussian-distributed pixel splat is parameterized by a mean value and a covariance matrix with color information and opacity. Conventional 3DGS projects the center points of 3D Gaussians onto a two-dimensional (2D) image plane and then splats (projects 3D pixel distributions onto a 2D plane) the Gaussians at the projected center point locations, circumventing the computationally intensive task of ray tracing through 3D space.

The splatting mechanism of conventional 3DGS utilizes an approximate affine transformation to reshape the projected 3D Gaussian as a 2D Gaussian on the 2D image plane. The perspective rendering of the original 3D distribution of the Gaussians may be distorted by this mechanism, with negative impacts on view quality.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a 3D Gaussian splatting system in one embodiment.

FIG. 2 depicts an example of a 3D Gaussian splatting process.

FIG. 3 depicts a conventional 3DGS mechanism.

FIG. 4 depicts a 3D Gaussian splatting mechanism that accurately reflects perspective projections.

FIG. 5 depicts a parallel processing unit in accordance with one embodiment.

FIG. 6 depicts a general processing cluster in accordance with one embodiment.

FIG. 7 depicts a memory partition unit in accordance with one embodiment.

FIG. 8 depicts a streaming multiprocessor in accordance with one embodiment.

FIG. 9 depicts a processing system in accordance with one embodiment.

FIG. 10 depicts an exemplary processing system in accordance with another embodiment.

FIG. 11 depicts a graphics processing pipeline in accordance with one embodiment.

### DETAILED DESCRIPTION

Disclosed herein are mechanisms for splatting 3D Gaussian distributions that achieve exact perspective geometric transformation. Pixels are un-projected from 2D planes to 3D space by applying queries to the 3D Gaussians at an expected un-projected ray depth position. This mechanism implements inverse camera projection without incurring the distortions of conventional 3DGS.

To mitigate numerical instability, the 3D Gaussian may be queried via 3D low-pass filtering, which also may mitigate anti-aliasing effects. The disclosed mechanisms may also utilize pixel super-sampling to further mitigate anti-aliasing in the renderings. Novel densification and pruning mechanisms may also be utilized to balance rendering quality and computational efficiency. A novel training objective may be configured for models that implement the disclosed 3DGS mechanisms.

The disclosed mechanisms determine the expectations of ray-to-3D Gaussian intersection positions and may be applicable for generating detailed and realistic 3D models from 2D images. Gaussian degeneration issues may be mitigated by low-pass 3D filtering. The 3D filter strengths may be computed differently for each Gaussian and each view for improved rendering quality. Direct super-sampling may be applied when rendering lower-resolution images.

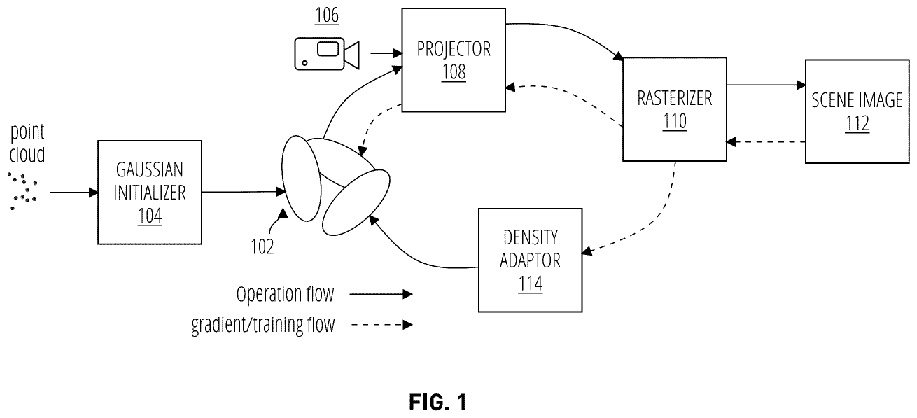

FIG. 1 depicts a 3D Gaussian splatting system in one embodiment. A set of 3D Gaussians 102 is initialized (Gaussian initializer 104) from a data set, e.g., a point cloud representation of a set of images. The initial Gaussians 102 and a virtual camera 106 intrinsic are transformed through a projector 108 into 2D splats for a rasterizer 110 to use when generating a scene image 112.

To optimize the configuration of the set of Gaussians 102 for depicting a particular scene (collection of images) in arbitrary views, a gradient loss (e.g., L1 or L2 loss) is determined for the generated scene image 112 and passed to a density adaptor 114 for the Gaussians 102. A gradient loss is also passed to the projector 108 for modifying pixel characteristics of the Gaussian 102.

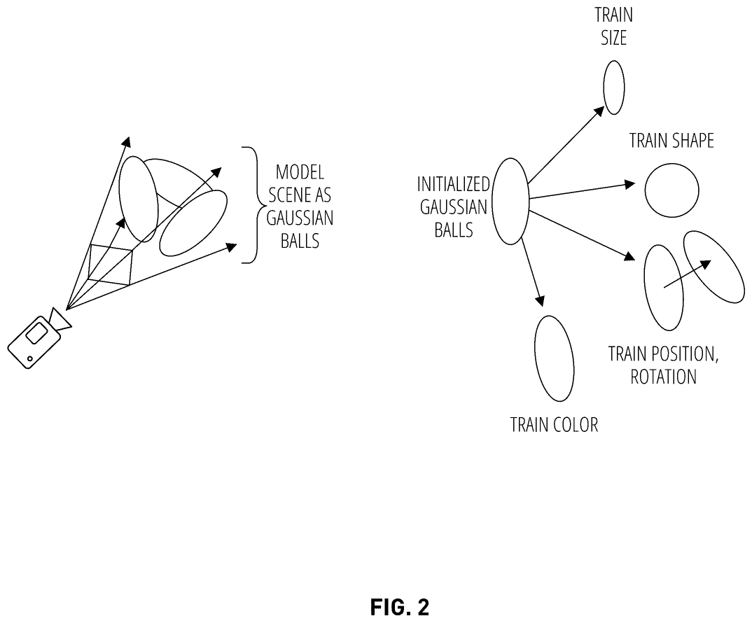

FIG. 2 depicts an example of a 3D Gaussian splatting process. A scene comprising an image is modeled as a large number of 3D Gaussian pixel distributions that are projected and depth-ordered on an image projection plane. One or more of a size, shape, position, rotation, and color of the pixels in the distributions may be estimated by a model trained on large image data sets. 3DGS mechanisms may be utilized to achieve real-time, high-fidelity scene rendering.

Gaussian splatting renders pixels in a 3D space as Gaussian-shaped 2D blobs. The 3D coordinates of the pixels to be rendered are gathered, e.g., as a point cloud, including attributes such as color or intensity. Parameters are defined for the virtual camera that project the 3D points onto a 2D plane. The view and camera parameters may be organized into matrices. The Gaussian kernel to apply is defined, centered at each rendering point and characterized by parameters such as width (standard deviation) and opacity (influence radius).

The 3D Gaussian shapes generated by the kernel are projected into rasterized 2D renderings on the imaging plane. Each point is transformed into a 2D Gaussian blob on the plane using the predefined Gaussian kernel. Contributions from each rendered point are accumulated into to the final rendered image. This involves blending overlapping Gaussian blobs, which can be achieved using techniques like additive (alpha) blending to achieve smooth transitions between points.

Gaussian splatting is computationally efficient and particularly useful for volumetric and real-time applications. The smooth interpolation of pixel points assists in rendering intricate details within the volume.

The Gaussians may adapt to scene details without grid structure constraints. Hundreds, thousands, or even millions of Gaussians may by projected to model a scene. Conventional Gaussian splatting mechanisms may utilize Elliptical Weighted Average volume splatting and a low-pass Gaussian kernel to apply the splats. The splatted Gaussians may be enlarged via dilation to prevent degeneration.

Elliptical Weighted Average volume splatting is a technique used in rendering to project 3D volume data onto a 2D image plane. It aids in generating images from volumetric datasets by representing each data point as an elliptically-shaped kernel. Each voxel in a volume to splat may be associated with an elliptical kernel. The shape and orientation of the ellipse are determined based on the voxel's properties and viewing direction. During rendering, the kernels are projected onto the image plane, or “splatted,” where they contribute to the final pixel values. This projection considers the view transformation, ensuring correct scaling and orientation on the 2D plane.

To improve the image quality, filtering may be applied among the contributions of nearby kernels. This smooths the blending of voxel projections and helps mitigate aliasing-especially beneficial for datasets with high-frequency content. Each pixel value on the image plane may be computed as a weighted sum of all overlapping kernel contributions. The weights are derived from the sampled kernels, emphasizing contributions closer to the ellipsoid center.

Gaussian distributions are one example of a probability density function. A probability density function (PDF) is a mathematical function that describes the likelihood of a continuous random variable falling within a particular range. It provides the probability that the variable takes a value within a certain interval, rather than the value of the variable at a specific coordinate. Properties of a probability density function f(x) include:

f(x)≥0 for all x;
The total area under the probability density function curve is equal to 1, i.e., ∫_{-∞}^{∞}f(x)dx=1;
The probability that a random variable x falls within an interval [a, b] is given by P(α≤x≤b)=∫ₐ^{b}f(x)dx.

Other examples of probability density functions include the normal distributions, exponential distributions, and uniform distributions.

A three-dimensional Gaussian distribution (henceforth, just “Gaussian”) has the general form

$$G ( x ) = a \times {e}^{( - 0.5 {( x - μ )}^{T} {\sum }^{- 1} ( x - μ ) )} \qquad Equation 1$$

where a is a normalization factor.

In Equation 1, x is the variable to distribute in three-dimensions, e.g., pixel coordinates {x,y,z}; μ is a three-dimensional center coordinate for the distribution; Σ⁻¹ is the inverse of the 9-dimensional covariance matrix for the distribution; and T denotes vector transposition.

Conventional 3DGS models a scene as a set of 3D Gaussians where each Gaussian is parameterized by its center position μ∈R³, covariance matrix Σ∈R^{3×3}, an opacity α∈[0, 1], and spherical harmonic (SH) coefficients c∈R^{(d+1)}^{²}^{×3} of degree d, for view-dependent colors.

The covariance matrix of an anisotropic Gaussian distribution may be decomposed into scaling matrix S∈R^{3×3} derived from scaling factors s∈R³ and rotation matrix r∈R⁴, and computed as:

$$\sum = r \cdot s \cdot {s}^{T} {r}^{T}$$

A number K of 3D Gaussians

$$G = \{ {μ}_{k} , {s}_{k} , {r}_{k} , {α}_{k} , {c}_{k} \} , k = 1 to K ,$$

are optimized by applying into the rasterization process the density function G(·) with the normalization factor obviated by setting a=1.

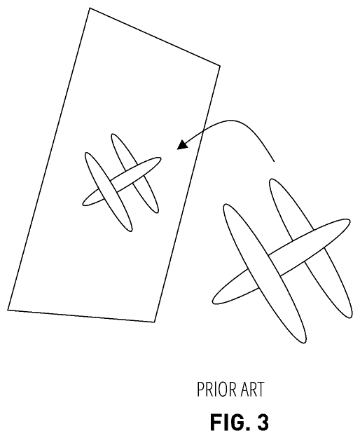

A conventional 3DGS mechanism (see FIG. 3) may involve three steps:
(1) project the center of a 3D Gaussian onto a 2D image plane;
(2) splat the projected 3D Gaussian to a 2D Gaussian at the center point; and
(3) repeat this process while alpha blending pixel values from the splats on the 2D image plane.

As known in the art, pixel alpha blending involves combining foreground (currently splatted pixels) and background (earlier splatted pixels) while controlling the transparency, resulting in a composite image. Alpha blending utilizes an alpha channel of the pixels, which represents the opacity of the image pixels.

The alpha-blending process for compositing the 2D Gaussians on the image plane may be expressed as

$$c ( p ) = {\sum }_{i = 1}^{N} {ω}_{{k}_{i}} \cdot ( {SH ( v )}^{T} {c}_{{k}_{i}} ) \qquad Equation 2$$

$${ω}_{{k}_{i}} = {\overline{α}}_{{k}_{i}} {\prod }_{j = 1}^{i - 1} ( 1 - {\overline{α}}_{{k}_{j}} ) , where {\overline{α}}_{{k}_{i}} = {α}_{{k}_{i}} \cdot {G}^{″}$$

where wₖ_{ᵢ} is a contribution weight of the Gaussian to the pixel, cₖ_{ᵢ} is a spherical harmonic coefficient of the Gaussian at the pixel, SH is a deterministic function mapping the viewing direction v to a spherical harmonic color multiplier SH(v), and G″ is the image plane 2D Gaussian distribution. Function SH(v) combines trainable spherical harmonic coefficients with the colors: pixel color=SH(v)^{T}cₖ_{ᵢ}.

To render a perspective camera view using conventional 3DGS, Equation 1 is applied to transform world-space Gaussians (μ, Σ) into camera space (u′, Σ′) and then again to the 2D image plane (μ″, Σ″), at each step applying local affine transformations (a linear transformation followed by a translation that preserves points, straight lines, and planes). However, the consequence of using the affine transformations is that the rendering does not always accurately reflect a true perspective projection.

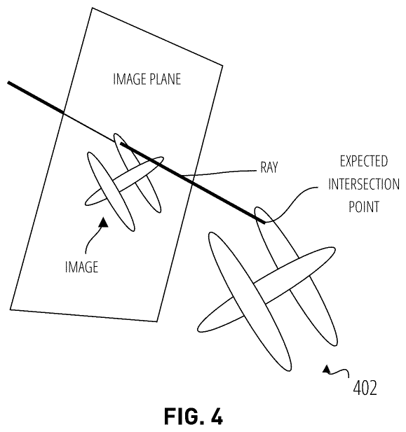

FIG. 4 depicts an unconventional 3D Gaussian splatting mechanism that accurately reflects perspective projections. Instead of the conventional mechanism of splatting on a 2D image plane, the disclosed mechanisms determine a proper pixel depth t* at image coordinates with ray direction r_{d} by finding the expected location on a Gaussian distributions for pixels that are unprojected from the image plane. The distribution of points t*r_{d} on 3D Gaussians 402 in camera space is then made as follows:

$$G ( t * {r}_{d} ) = {e}^{( - 0.5 {( t * {r}_{d} - {μ}^{′} )}^{T} {( {\sum }^{′} )}^{- 1} ( t * {r}_{d} - {μ}^{′} ) )} , \qquad Equation 3 a$$

$$where {r}_{d} = {K}^{- 1} [ \begin{matrix}i & j & {1 ]}^{T}\end{matrix}$$

Here K is the camera intrinsic matrix, [i j 1]^{T} is a pixel coordinate, and G (·) is the density function at the pixel ray in camera space. The camera intrinsic matrix K relates pixel coordinates in an image to corresponding coordinates in the camera's sensor. It encapsulates the internal parameters of a camera, which may include scaling factors in the x and y directions of the image plane, often related to the physical focal length of the lens and the size of the camera's pixels, the point where the optical axis intersects the image plane, typically near the center of the image, and for some cameras, coefficients to account for skewness or non-orthogonality between the x and y pixel axes. The camera position may be set to rₒ=[0 0 0]^{T} in the camera space.

The t* values may be computed as:

$$t * = \frac{{( {μ}^{′} )}^{T} {( {\sum }^{′} )}^{- 1} {r}_{d}}{{{r}_{d}^{T} ( {\sum }^{′} )}^{- 1} {r}_{d}} \qquad Equation 3 b$$

The disclosed rendering mechanisms may be implemented by replacing the 2D image plane Gaussian distribution G″ in alpha blending Equation 2 with a forward 3D Gaussian evaluation function

$$G ( t * {r}_{d} ) = exp ( 0.5 \cdot \frac{{( {( {u}^{′} )}^{T} {( {\sum }^{′} )}^{- 1} {r}_{d} )}^{2}}{{{r}_{d}^{T} ( {\sum }^{′} )}^{- 1} {r}_{d}} - 0.5 {( {u}^{′} )}^{T} {( {\sum }^{′} )}^{- 1} {u}^{′} ) , \qquad Equation 4$$

$$where {r}_{d} = {K}^{- 1} [ \begin{matrix}i & j & {1 ]}^{T}\end{matrix}$$

where Equation 4 is Equation 3a with the expanded form of t* from Equation 3b. Gradient descent may be applied to train the center points (means) and covariance matrices for the 3D Gaussians by applying the following backward gradients:

$$\frac{\partial G}{\partial {μ}^{′}} = G ( t * {r}_{d} ) {( {\sum }^{′} )}^{- 1} ( t * {r}_{d} - {u}^{′} )$$

$$\frac{\partial G}{\partial {\sum }^{′}} = 0.5 \cdot G ( t * {r}_{d} ) \cdot {( {\sum }^{′} )}^{- 1} ( t * {r}_{d} - {μ}^{′} ) {( t * {r}_{d} - u )}^{T} \cdot {( {\sum }^{′} )}^{- 1}$$

The gradient descent applies back propagation to optimize the 3D Gaussians to fit a particular scene specification. The backpropagation adapts the Gaussian attributes of position, rotation, scaling, opacity and color to fit a particular (volumetric) scene specification.

The disclosed mechanisms may be readily adapted to different camera projections by adapting

$${r}_{d} = {K}^{- 1} [ \begin{matrix}i & j & {1 ]}^{T}\end{matrix}$$

per the target camera intrinsic (e.g., 360 equirectangular, fish-eye), obviating the local affine approximation employed by conventional spatting algorithms for different camera projections.

During training, some of the Gaussians may degenerate to sizes smaller than the pixels in the training views. Computation with small 3D Gaussians may prove to be numerical unstable. They may cause noisy rendering on some unbounded scenes and may lead to the Gaussians duplicating excessively during adaptive densification procedure due to the incorrect gradient, eventually causing out-of-memory conditions during computation.

To prevent the numerical issue due to small-sized Gaussians, a low-pass Gaussian filter may be applied to the primitives in conventional Elliptical Weighted Average volume splatting. Applying a low-pass kernel may help ensure that the Gaussians have a reasonable scale relative to the pixels capturing the Gaussians. Using Gaussian as the low-pass kernel is also efficient to compute as convolving two Gaussians produce another Gaussian with simple closed form. The disclosed mechanisms enhance the Elliptical Weighted Average volume splatting process by applying the low-pass Gaussian kernel (filter) directly in three-dimensional space:

$$Equation 5$$

$${G}_{{μ}^{′} , {\sum }^{′}} ( t * {r}_{d} ) = \frac{{s}_{x} \cdot {s}_{y} \cdot {s}_{z}}{( {s}_{x}^{2} + {σ}^{2} ) \cdot ( {s}_{y}^{2} + {σ}^{2} ) \cdot ( {s}_{z}^{2} + {σ}^{2} )} \cdot {G}_{{μ}^{′} , ( {\sum }^{′} + {σ}^{2} I )} ( t * {r}_{d} )$$

where sₓ, s_{y}, and s_{z} are the Gaussian scaling parameters to be optimized. The first term provides normalization of the Gaussians and σ₂ is the variance of the low-pass kernel. The blurring filter strength (σ) varies with different Gaussians k under different views i:

$${σ}_{k , i} = {λ}_{σ} \cdot {μ}_{k , z}^{′} / {f}_{i} \qquad Equation 6$$

where μ′_{k,z} is the Gaussian z-depth from the camera, fᵢ is the camera focal length, and u′_{k,z}/fᵢ is the distance between nearby pixels in the z-plane to the location of the Gaussian splat. The symbol λ_{σ} represents a hyperparameter that determines the standard deviation of the low-pass kernel in pixel units. The filter may enlarge the Gaussian and decay its opacity.

The 3D filtering in Equation 5 may be understood as a sampling algorithm for the Gaussian primitives that calculates the expectation over a 3D volume whose scale is proportion to the distance and pixel size (Equation 6).

The volume sampling may become inaccurate for large values of σ for the low-pass Gaussians. In this case, super-sampling may be utilized to use more but smaller Gaussian kernels. A large μ′_{k,z} (z-depth) may be unavoidable, and therefore a threshold λ_{1/f} may be configured to bound the maximum pixel size at unit z-plane depth (i.e., 1/f). When the camera pixel size exceeds this bound, the scene may be super-sampled with resolution λ_{1/f} and the resulting rendered image may then be down-sampled to a target resolution.

A Gaussian may during rendering take on a size smaller than any pixels of the views used to train the model. These small-sized Gaussians may appear as high-frequency artifacts in the rendered scene, especially when rendering at lower z-depths or higher resolutions. A training objective may be configured for the model to regularize the Gaussians to a similar appearance before and after the low-pass filtering is applied. For example, an L1 loss may be applied to the scale values sₖ of k^{th} Gaussian when the scale values exceed a configured minimum s_{k,min}:

$${s}_{k , min}^{3} = {λ}_{s} \cdot \sqrt{{( {s}_{k , min}^{2} + {σ}_{k , min}^{2} )}^{3}} , where {σ}_{k , min} = {min}_{i} {σ}_{k , i}$$

where σ_{k,min} is the smallest low-pass kernel from the views used to train the model, and λₛ is a model hyperparameter for the target minimum ratio between the volume before and after the low-pass filter.

Conventional 3DGS mechanisms gradually adjust the number of Gaussians used to render the scene using techniques such as pruning and densification. The disclosed mechanisms may apply a criteria not found in conventional 3DGS mechanisms to determine which Gaussians should be pruned and densified, to provide a balance between model output quality and model size.

Conventional 3DGS prunes Gaussians with α<ϵ_{α}, i.e., those Gaussians with an opacity lower than a configured threshold. Unlike conventional 3DGS, the disclosed mechanisms may configure a maximum blending weight mx to measure the contribution of each Gaussian to the training views:

$${m}_{k} = {max}_{p} ( {w}_{k} ( p ) ) ,$$

where wₖ(p) indicates the blending weight (see Equation 2) of the k^{th} Gaussian, viewed from pixel p. The value of mₖ may be determined across multiple training views. Gaussians that satisfy m<ϵₘ may be pruned from use with mₖ to zero after each pruning.

Conventional 3DGS may also duplicate Gaussians that have a densification priority above a configured threshold q>ϵ_{q}. The threshold may adapt to different scenes, resulting in a different number of Gaussians used for each scene. Unlike conventional 3DGS, the disclosed mechanisms may duplicate a top Q number of Gaussians having the highest q value instead. This controls the number of Gaussians to add per scene by setting the budget Q. The disclosed mechanisms may project the 3D positional gradient

$$- \frac{\partial ζ}{\partial C ( p )}$$

back to view-space to inherit the hyperparameters utilized in conventional 3DGS. A priority metric

$${q}_{k} = {\sum }_{p} {w}_{k} ( p ) \cdot {\vert \frac{\partial ζ}{\partial C ( p )} \vert}_{1}$$

may be computed to accumulate the gradient of the rendered pixels, weighted by the blending weight of the k-th Gaussian. This priority metric may be more directly correlated to improved perceptual quality of the rendered scene.

The mechanisms disclosed herein may be implemented in and/or by computing devices utilizing one or more graphic processing unit (GPU) and/or general purpose data processor (e.g., a ‘central processing unit or CPU). For example one or more systems (see below) comprising one or more GPUs may comprise memory configured with instructions that implement the 3DGS and rasterization mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

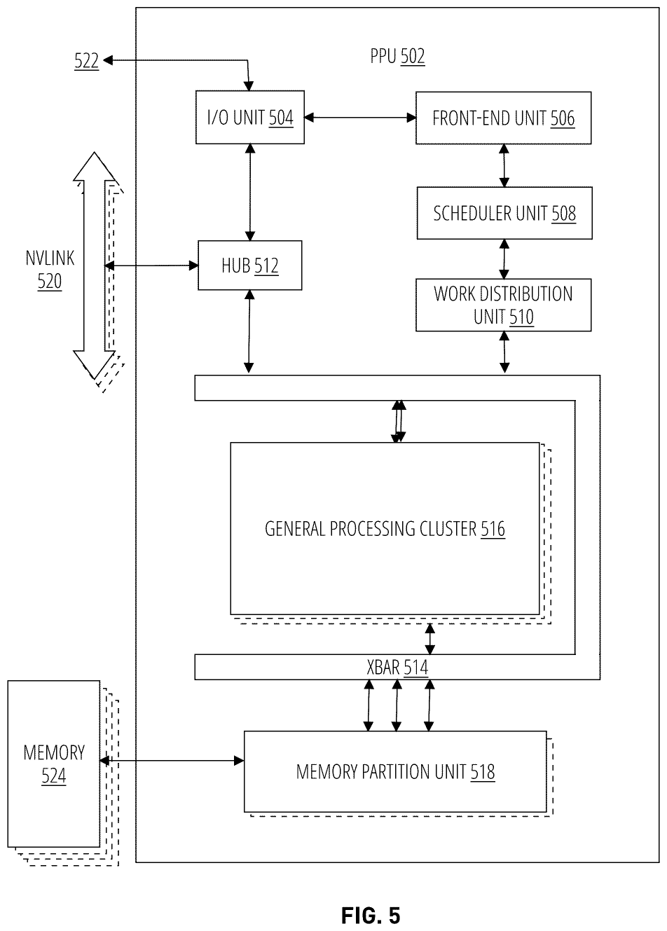

FIG. 5 depicts a parallel processing unit 502, in accordance with an embodiment. In an embodiment, the parallel processing unit 502 is a multi-threaded processor that is implemented on one or more integrated circuit devices. The parallel processing unit 502 is a latency hiding architecture designed to process many threads in parallel. A thread (e.g., a thread of execution) is an instantiation of a set of instructions configured to be executed by the parallel processing unit 502. In an embodiment, the parallel processing unit 502 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 502 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 502 modules may be configured to accelerate thousands of High Performance Computing (HPC), data center, and machine learning applications. The parallel processing unit 502 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 502 includes an I/O unit 504, a front-end unit 506, a scheduler unit 508, a work distribution unit 510, a hub 512, a crossbar 514, one or more general processing cluster 516 modules, and one or more memory partition unit 518 modules. The parallel processing unit 502 may be connected to a host processor or other parallel processing unit 502 modules via one or more high-speed NVLink 520 interconnects. The parallel processing unit 502 may be connected to a host processor or other peripheral devices via an interconnect 522. The parallel processing unit 502 may also be connected to a local memory comprising a number of memory 524 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 524 may comprise logic to configure the parallel processing unit 502 to carry out aspects of the techniques disclosed herein.

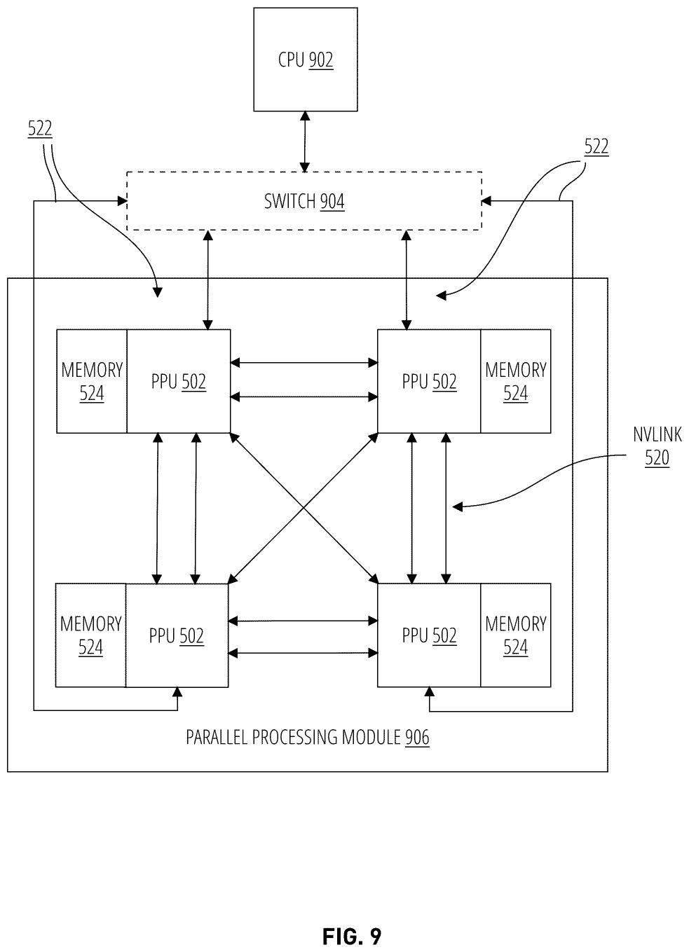

The NVLink 520 interconnect enables systems to scale and include one or more parallel processing unit 502 modules combined with one or more CPUs, supports cache coherence between the parallel processing unit 502 modules and CPUs, and CPU mastering. Data and/or commands may be transmitted by the NVLink 520 through the hub 512 to/from other units of the parallel processing unit 502 such as one or more copy engines, a video encoder, a video decoder, a power management unit, etc. (not explicitly shown). The NVLink 520 is described in more detail in conjunction with FIG. 9.

The I/O unit 504 is configured to transmit and receive communications (e.g., commands, data, etc.) from a host processor (not shown) over the interconnect 522. The I/O unit 504 may communicate with the host processor directly via the interconnect 522 or through one or more intermediate devices such as a memory bridge. In an embodiment, the I/O unit 504 may communicate with one or more other processors, such as one or more parallel processing unit 502 modules via the interconnect 522. In an embodiment, the I/O unit 504 implements a Peripheral Component Interconnect Express (PCIe) interface for communications over a PCIe bus and the interconnect 522 is a PCIe bus. In alternative embodiments, the I/O unit 504 may implement other types of well-known interfaces for communicating with external devices.

The I/O unit 504 decodes packets received via the interconnect 522. In an embodiment, the packets represent commands configured to cause the parallel processing unit 502 to perform various operations. The I/O unit 504 transmits the decoded commands to various other units of the parallel processing unit 502 as the commands may specify. For example, some commands may be transmitted to the front-end unit 506. Other commands may be transmitted to the hub 512 or other units of the parallel processing unit 502 such as one or more copy engines, a video encoder, a video decoder, a power management unit, etc. (not explicitly shown). In other words, the I/O unit 504 is configured to route communications between and among the various logical units of the parallel processing unit 502.

In an embodiment, a program executed by the host processor encodes a command stream in a buffer that provides workloads to the parallel processing unit 502 for processing. A workload may comprise several instructions and data to be processed by those instructions. The buffer is a region in a memory that is accessible (e.g., read/write) by both the host processor and the parallel processing unit 502. For example, the I/O unit 504 may be configured to access the buffer in a system memory connected to the interconnect 522 via memory requests transmitted over the interconnect 522. In an embodiment, the host processor writes the command stream to the buffer and then transmits a pointer to the start of the command stream to the parallel processing unit 502. The front-end unit 506 receives pointers to one or more command streams. The front-end unit 506 manages the one or more streams, reading commands from the streams and forwarding commands to the various units of the parallel processing unit 502.

The front-end unit 506 is coupled to a scheduler unit 508 that configures the various general processing cluster 516 modules to process tasks defined by the one or more streams. The scheduler unit 508 is configured to track state information related to the various tasks managed by the scheduler unit 508. The state may indicate which general processing cluster 516 a task is assigned to, whether the task is active or inactive, a priority level associated with the task, and so forth. The scheduler unit 508 manages the execution of a plurality of tasks on the one or more general processing cluster 516 modules.

The scheduler unit 508 is coupled to a work distribution unit 510 that is configured to dispatch tasks for execution on the general processing cluster 516 modules. The work distribution unit 510 may track a number of scheduled tasks received from the scheduler unit 508. In an embodiment, the work distribution unit 510 manages a pending task pool and an active task pool for each of the general processing cluster 516 modules. The pending task pool may comprise a number of slots (e.g., 32 slots) that contain tasks assigned to be processed by a particular general processing cluster 516. The active task pool may comprise a number of slots (e.g., 4 slots) for tasks that are actively being processed by the general processing cluster 516 modules. As a general processing cluster 516 finishes the execution of a task, that task is evicted from the active task pool for the general processing cluster 516 and one of the other tasks from the pending task pool is selected and scheduled for execution on the general processing cluster 516. If an active task has been idle on the general processing cluster 516, such as while waiting for a data dependency to be resolved, then the active task may be evicted from the general processing cluster 516 and returned to the pending task pool while another task in the pending task pool is selected and scheduled for execution on the general processing cluster 516.

The work distribution unit 510 communicates with the one or more general processing cluster 516 modules via crossbar 514. The crossbar 514 is an interconnect network that couples many of the units of the parallel processing unit 502 to other units of the parallel processing unit 502. For example, the crossbar 514 may be configured to couple the work distribution unit 510 to a particular general processing cluster 516. Although not shown explicitly, one or more other units of the parallel processing unit 502 may also be connected to the crossbar 514 via the hub 512.

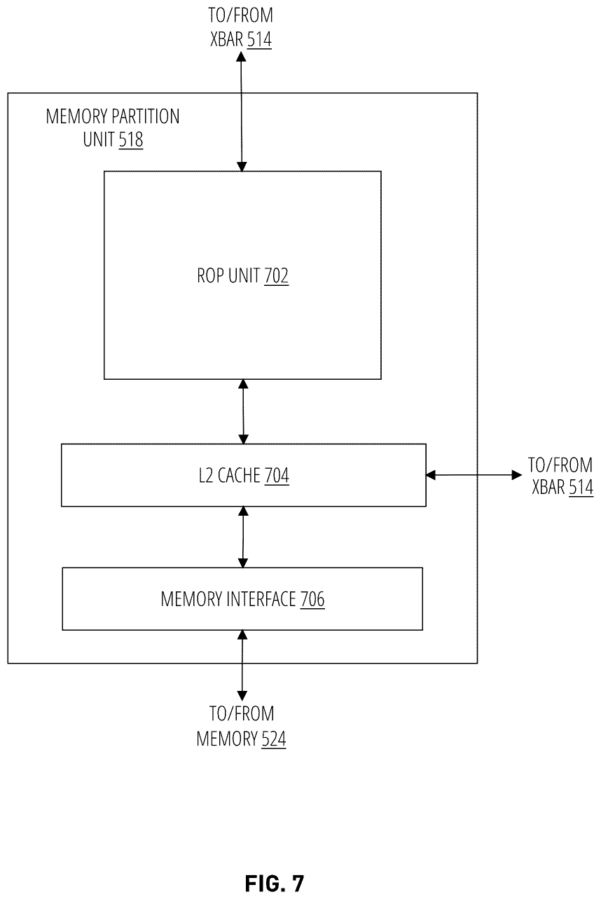

The tasks are managed by the scheduler unit 508 and dispatched to a general processing cluster 516 by the work distribution unit 510. The general processing cluster 516 is configured to process the task and generate results. The results may be consumed by other tasks within the general processing cluster 516, routed to a different general processing cluster 516 via the crossbar 514, or stored in the memory 524. The results can be written to the memory 524 via the memory partition unit 518 modules, which implement a memory interface for reading and writing data to/from the memory 524. The results can be transmitted to another parallel processing unit 502 or CPU via the NVLink 520. In an embodiment, the parallel processing unit 502 includes a number U of memory partition unit 518 modules that is equal to the number of separate and distinct memory 524 devices coupled to the parallel processing unit 502. A memory partition unit 518 will be described in more detail below in conjunction with FIG. 7.

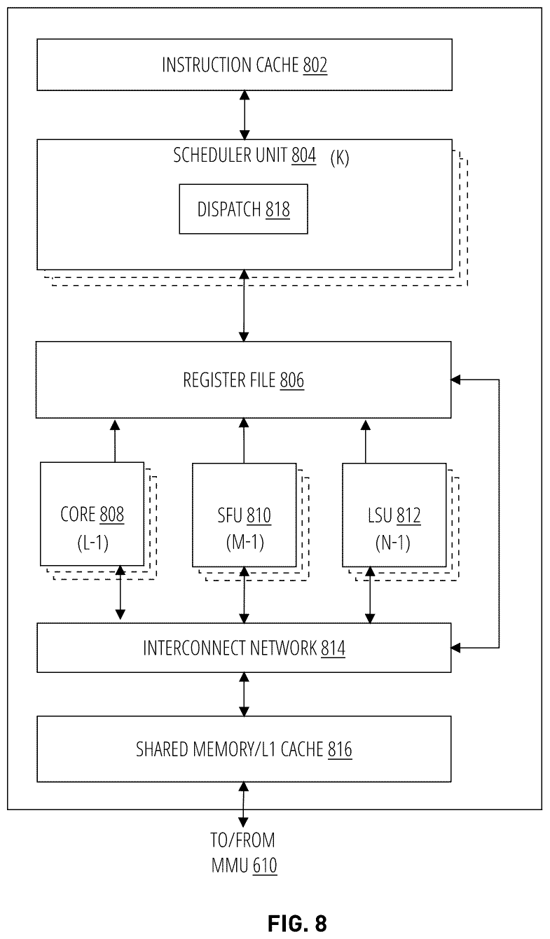

In an embodiment, a host processor executes a driver kernel that implements an application programming interface (API) that enables one or more applications executing on the host processor to schedule operations for execution on the parallel processing unit 502. In an embodiment, multiple compute applications are simultaneously executed by the parallel processing unit 502 and the parallel processing unit 502 provides isolation, quality of service (QoS), and independent address spaces for the multiple compute applications. An application may generate instructions (e.g., API calls) that cause the driver kernel to generate one or more tasks for execution by the parallel processing unit 502. The driver kernel outputs tasks to one or more streams being processed by the parallel processing unit 502. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

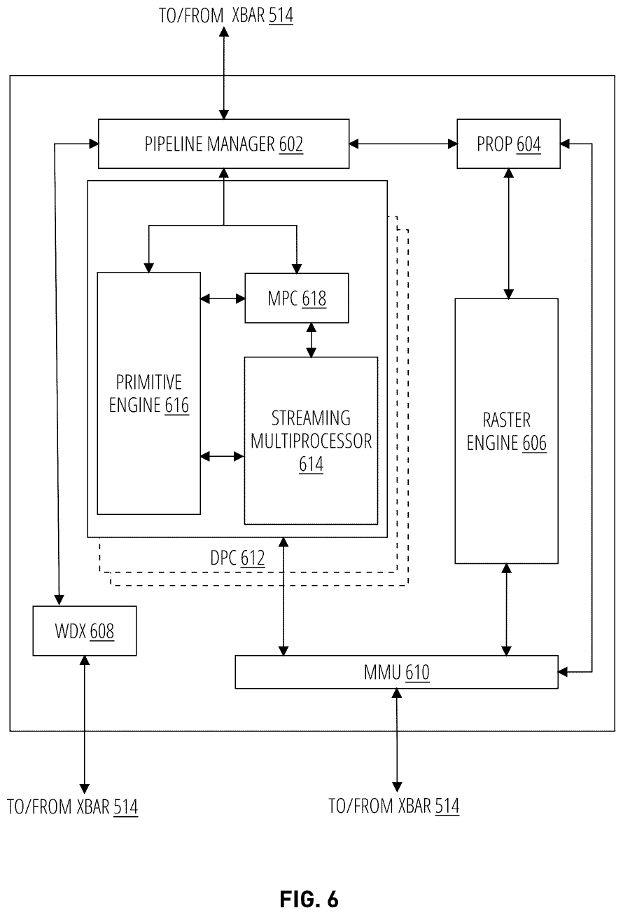

FIG. 6 depicts a general processing cluster 516 of the parallel processing unit 502 of FIG. 5, in accordance with an embodiment. As shown in FIG. 6, each general processing cluster 516 includes a number of hardware units for processing tasks. In an embodiment, each general processing cluster 516 includes a pipeline manager 602, a pre-raster operations unit 604, a raster engine 606, a work distribution crossbar 608, a memory management unit 610, and one or more data processing cluster 612. It will be appreciated that the general processing cluster 516 of FIG. 6 may include other hardware units in lieu of or in addition to the units shown in FIG. 6.

In an embodiment, the operation of the general processing cluster 516 is controlled by the pipeline manager 602. The pipeline manager 602 manages the configuration of the one or more data processing cluster 612 modules for processing tasks allocated to the general processing cluster 516. In an embodiment, the pipeline manager 602 may configure at least one of the one or more data processing cluster 612 modules to implement at least a portion of a graphics rendering pipeline. For example, a data processing cluster 612 may be configured to execute a vertex shader program on the programmable streaming multiprocessor 614. The pipeline manager 602 may also be configured to route packets received from the work distribution unit 510 to the appropriate logical units within the general processing cluster 516. For example, some packets may be routed to fixed function hardware units in the pre-raster operations unit 604 and/or raster engine 606 while other packets may be routed to the data processing cluster 612 modules for processing by the primitive engine 616 or the streaming multiprocessor 614. In an embodiment, the pipeline manager 602 may configure at least one of the one or more data processing cluster 612 modules to implement a neural network model and/or a computing pipeline.

The pre-raster operations unit 604 is configured to route data generated by the raster engine 606 and the data processing cluster 612 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 606 includes a number of fixed function hardware units configured to perform various raster operations. In an embodiment, the raster engine 606 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 606 comprises fragments to be processed, for example, by a fragment shader implemented within a data processing cluster 612.

Each data processing cluster 612 included in the general processing cluster 516 includes an M-pipe controller 618, a primitive engine 616, and one or more streaming multiprocessor 614 modules. The M-pipe controller 618 controls the operation of the data processing cluster 612, routing packets received from the pipeline manager 602 to the appropriate units in the data processing cluster 612. For example, packets associated with a vertex may be routed to the primitive engine 616, which is configured to fetch vertex attributes associated with the vertex from the memory 524. In contrast, packets associated with a shader program may be transmitted to the streaming multiprocessor 614.

The streaming multiprocessor 614 comprises a programmable streaming processor that is configured to process tasks represented by a number of threads. Each streaming multiprocessor 614 is multi-threaded and configured to execute a plurality of threads (e.g., 32 threads) from a particular group of threads concurrently. In an embodiment, the streaming multiprocessor 614 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 614 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 614 will be described in more detail below in conjunction with FIG. 8.

The memory management unit 610 provides an interface between the general processing cluster 516 and the memory partition unit 518. The memory management unit 610 may provide translation of virtual addresses into physical addresses, memory protection, and arbitration of memory requests. In an embodiment, the memory management unit 610 provides one or more translation lookaside buffers (TLBs) for performing translation of virtual addresses into physical addresses in the memory 524.

FIG. 7 depicts a memory partition unit 518 of the parallel processing unit 502 of FIG. 5, in accordance with an embodiment. As shown in FIG. 7, the memory partition unit 518 includes a raster operations unit 702, a level two cache 704, and a memory interface 706. The memory interface 706 is coupled to the memory 524. Memory interface 706 may implement 32, 64, 128, 1024-bit data buses, or the like, for high-speed data transfer. In an embodiment, the parallel processing unit 502 incorporates U memory interface 706 modules, one memory interface 706 per pair of memory partition unit 518 modules, where each pair of memory partition unit 518 modules is connected to a corresponding memory 524 device. For example, parallel processing unit 502 may be connected to up to Y memory 524 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 502, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 524 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 502 modules process very large datasets and/or run applications for extended periods.

In an embodiment, the parallel processing unit 502 implements a multi-level memory hierarchy. In an embodiment, the memory partition unit 518 supports a unified memory to provide a single unified virtual address space for CPU and parallel processing unit 502 memory, enabling data sharing between virtual memory systems. In an embodiment the frequency of accesses by a parallel processing unit 502 to memory located on other processors is traced to ensure that memory pages are moved to the physical memory of the parallel processing unit 502 that is accessing the pages more frequently. In an embodiment, the NVLink 520 supports address translation services allowing the parallel processing unit 502 to directly access a CPU's page tables and providing full access to CPU memory by the parallel processing unit 502.

In an embodiment, copy engines transfer data between multiple parallel processing unit 502 modules or between parallel processing unit 502 modules and CPUs. The copy engines can generate page faults for addresses that are not mapped into the page tables. The memory partition unit 518 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 524 or other system memory may be fetched by the memory partition unit 518 and stored in the level two cache 704, which is located on-chip and is shared between the various general processing cluster 516 modules. As shown, each memory partition unit 518 includes a portion of the level two cache 704 associated with a corresponding memory 524 device. Lower level caches may then be implemented in various units within the general processing cluster 516 modules. For example, each of the streaming multiprocessor 614 modules may implement an L1 cache. The L1 cache is private memory that is dedicated to a particular streaming multiprocessor 614. Data from the level two cache 704 may be fetched and stored in each of the L1 caches for processing in the functional units of the streaming multiprocessor 614 modules. The level two cache 704 is coupled to the memory interface 706 and the crossbar 514.

The raster operations unit 702 performs graphics raster operations related to pixel color, such as color compression, pixel blending, and the like. The raster operations unit 702 also implements depth testing in conjunction with the raster engine 606, receiving a depth for a sample location associated with a pixel fragment from the culling engine of the raster engine 606. The depth is tested against a corresponding depth in a depth buffer for a sample location associated with the fragment. If the fragment passes the depth test for the sample location, then the raster operations unit 702 updates the depth buffer and transmits a result of the depth test to the raster engine 606. It will be appreciated that the number of partition memory partition unit 518 modules may be different than the number of general processing cluster 516 modules and, therefore, each raster operations unit 702 may be coupled to each of the general processing cluster 516 modules. The raster operations unit 702 tracks packets received from the different general processing cluster 516 modules and determines which general processing cluster 1 that a result generated by the raster operations unit 702 is routed to through the crossbar 514. Although the raster operations unit 702 is included within the memory partition unit 518 in FIG. 7, in other embodiment, the raster operations unit 702 may be outside of the memory partition unit 518. For example, the raster operations unit 702 may reside in the general processing cluster 516 or another unit.

FIG. 8 illustrates the streaming multiprocessor 614 of FIG. 6, in accordance with an embodiment. As shown in FIG. 8, the streaming multiprocessor 614 includes an instruction cache 802, one or more scheduler unit 804 modules (e.g., such as scheduler unit 508), a register file 806, one or more processing core 808 modules, one or more special function unit 810 modules, one or more load/store unit 812 modules, an interconnect network 814, and a shared memory/L1 cache 816.

As described above, the work distribution unit 510 dispatches tasks for execution on the general processing cluster 516 modules of the parallel processing unit 502. The tasks are allocated to a particular data processing cluster 612 within a general processing cluster 516 and, if the task is associated with a shader program, the task may be allocated to a streaming multiprocessor 614. The scheduler unit 508 receives the tasks from the work distribution unit 510 and manages instruction scheduling for one or more thread blocks assigned to the streaming multiprocessor 614. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 808 modules, special function unit 810 modules, and load/store unit 812 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 818 unit is configured within the scheduler unit 804 to transmit instructions to one or more of the functional units. In one embodiment, the scheduler unit 804 includes two dispatch 818 units that enable two different instructions from the same warp to be dispatched during each clock cycle. In alternative embodiments, each scheduler unit 804 may include a single dispatch 818 unit or additional dispatch 818 units.

Each streaming multiprocessor 614 includes a register file 806 that provides a set of registers for the functional units of the streaming multiprocessor 614. In an embodiment, the register file 806 is divided between each of the functional units such that each functional unit is allocated a dedicated portion of the register file 806. In another embodiment, the register file 806 is divided between the different warps being executed by the streaming multiprocessor 614. The register file 806 provides temporary storage for operands connected to the data paths of the functional units.

Each streaming multiprocessor 614 comprises L processing core 808 modules. In an embodiment, the streaming multiprocessor 614 includes a large number (e.g., 128, etc.) of distinct processing core 808 modules. Each core 808 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 808 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 808 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 614 also comprises M special function unit 810 modules that perform special functions (e.g., attribute evaluation, reciprocal square root, and the like). In an embodiment, the special function unit 810 modules may include a tree traversal unit configured to traverse a hierarchical tree data structure. In an embodiment, the special function unit 810 modules may include texture unit configured to perform texture map filtering operations. In an embodiment, the texture units are configured to load texture maps (e.g., a 2D array of texels) from the memory 524 and sample the texture maps to produce sampled texture values for use in shader programs executed by the streaming multiprocessor 614. In an embodiment, the texture maps are stored in the shared memory/L1 cache 816. The texture units implement texture operations such as filtering operations using mip-maps (e.g., texture maps of varying levels of detail). In an embodiment, each streaming multiprocessor 614 includes two texture units.

Each streaming multiprocessor 614 also comprises N load/store unit 812 modules that implement load and store operations between the shared memory/L1 cache 816 and the register file 806. Each streaming multiprocessor 614 includes an interconnect network 814 that connects each of the functional units to the register file 806 and the load/store unit 812 to the register file 806 and shared memory/L1 cache 816. In an embodiment, the interconnect network 814 is a crossbar that can be configured to connect any of the functional units to any of the registers in the register file 806 and connect the load/store unit 812 modules to the register file 806 and memory locations in shared memory/L1 cache 816.

The shared memory/L1 cache 816 is an array of on-chip memory that allows for data storage and communication between the streaming multiprocessor 614 and the primitive engine 616 and between threads in the streaming multiprocessor 614. In an embodiment, the shared memory/L1 cache 816 comprises 128 KB of storage capacity and is in the path from the streaming multiprocessor 614 to the memory partition unit 518. The shared memory/L1 cache 816 can be used to cache reads and writes. One or more of the shared memory/L1 cache 816, level two cache 704, and memory 524 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 816 enables the shared memory/L1 cache 816 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 510 assigns and distributes blocks of threads directly to the data processing cluster 612 modules. The threads in a block execute the same program, using a unique thread ID in the calculation to ensure each thread generates unique results, using the streaming multiprocessor 614 to execute the program and perform calculations, shared memory/L1 cache 816 to communicate between threads, and the load/store unit 812 to read and write global memory through the shared memory/L1 cache 816 and the memory partition unit 518. When configured for general purpose parallel computation, the streaming multiprocessor 614 can also write commands that the scheduler unit 508 can use to launch new work on the data processing cluster 612 modules.

The parallel processing unit 502 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 502 is embodied on a single semiconductor substrate. In another embodiment, the parallel processing unit 502 is included in a system-on-a-chip (SoC) along with one or more other devices such as additional parallel processing unit 502 modules, the memory 524, a reduced instruction set computer (RISC) CPU, a memory management unit (MMU), a digital-to-analog converter (DAC), and the like.

In an embodiment, the parallel processing unit 502 may be included on a graphics card that includes one or more memory devices. The graphics card may be configured to interface with a PCIe slot on a motherboard of a desktop computer. In yet another embodiment, the parallel processing unit 502 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system implemented using the parallel processing unit 502 of FIG. 5, in accordance with an embodiment. The processing system includes a central processing unit 902, a switch 904, and multiple parallel processing unit 502 modules each and respective memory 524 modules. The switch 904 is depicted with dashed lines, indicating that it is optional in some embodiments.

The NVLink 520 provides high-speed communication links between each of the parallel processing unit 502 modules. Although a particular number of NVLink 520 and interconnect 522 connections are illustrated in FIG. 9, the number of connections to each parallel processing unit 502 and the central processing unit 902 may vary. The switch 904 interfaces between the interconnect 522 and the central processing unit 902. The parallel processing unit 502 modules, memory 524 modules, and NVLink 520 connections may be situated on a single semiconductor platform to form a parallel processing module 906. In an embodiment, the switch 904 supports two or more protocols to interface between various different connections and/or links.

In another embodiment (not shown), the NVLink 520 provides one or more high-speed communication links between each of the parallel processing unit modules (parallel processing unit 502, parallel processing unit 502, parallel processing unit 502, and parallel processing unit 502) and the central processing unit 902 and the switch 904 (when present) interfaces between the interconnect 522 and each of the parallel processing unit modules. The parallel processing unit modules, memory 524 modules, and interconnect 522 may be situated on a single semiconductor platform to form a parallel processing module 906. In yet another embodiment (not shown), the interconnect 522 provides one or more communication links between each of the parallel processing unit modules and the central processing unit 902 and the switch 904 interfaces between each of the parallel processing unit modules using the NVLink 520 to provide one or more high-speed communication links between the parallel processing unit modules. In another embodiment (not shown), the NVLink 520 provides one or more high-speed communication links between the parallel processing unit modules and the central processing unit 902 through the switch 904. In yet another embodiment (not shown), the interconnect 522 provides one or more communication links between each of the parallel processing unit modules directly. One or more of the NVLink 520 high-speed communication links may be implemented as a physical NVLink interconnect or either an on-chip or on-die interconnect using the same protocol as the NVLink 520.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 906 may be implemented as a circuit board substrate and each of the parallel processing unit modules and/or memory 524 modules may be packaged devices. In an embodiment, the central processing unit 902, switch 904, and the parallel processing module 906 are situated on a single semiconductor platform.

In an embodiment, each parallel processing unit module includes six NVLink 520 interfaces (as shown in FIG. 9, five NVLink 520 interfaces are included for each parallel processing unit module). The NVLink 520 may be operated exclusively for PPU-to-PPU communication as shown in FIG. 9, or some combination of PPU-to-PPU and PPU-to-CPU, when the central processing unit 902 also includes one or more NVLink 520 interfaces.

In an embodiment, the NVLink 520 allows direct load/store/atomic access from the central processing unit 902 to each parallel processing unit module's memory 524. In an embodiment, the NVLink 520 supports coherency operations, allowing data read from the memory 524 modules to be stored in the cache hierarchy of the central processing unit 902, reducing cache access latency for the central processing unit 902. In an embodiment, the NVLink 520 includes support for Address Translation Services (ATS), enabling the parallel processing unit module to directly access page tables within the central processing unit 902. One or more of the NVLink 520 may also be configured to operate in a low-power mode.

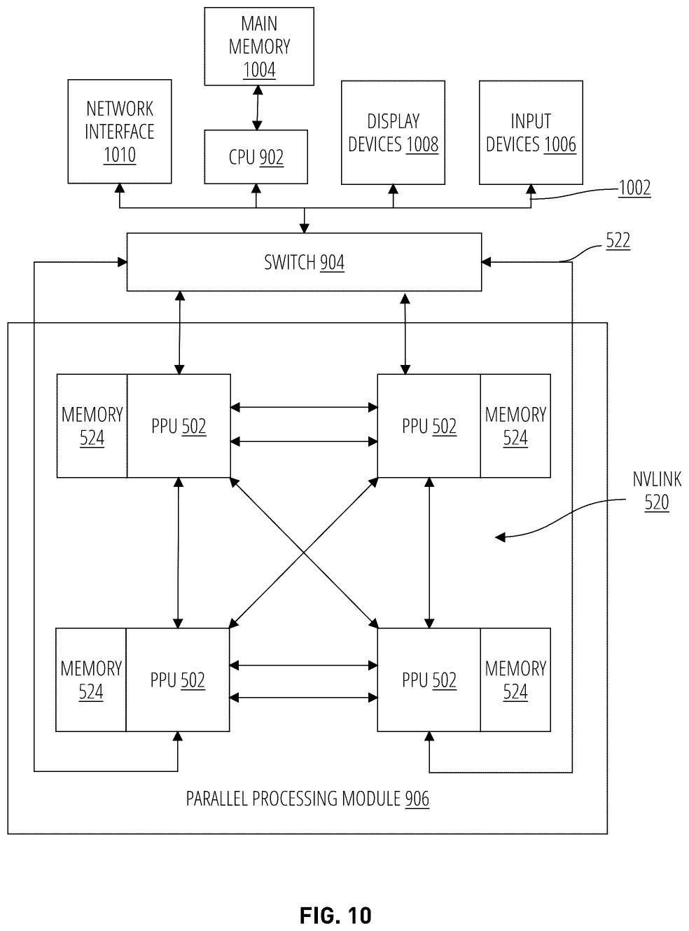

FIG. 10 depicts an exemplary processing system in which the various architecture and/or functionality of the various previous embodiments may be implemented. As shown, an exemplary processing system is provided including at least one central processing unit 902 that is connected to a communications bus 1002. The communication communications bus 1002 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1004. Control logic (software) and data are stored in the main memory 1004 which may take the form of random access memory (RAM).

The exemplary processing system also includes input devices 1006, the parallel processing module 906, and display devices 1008, e.g. a conventional CRT (cathode ray tube), LCD (liquid crystal display), LED (light emitting diode), plasma display or the like. User input may be received from the input devices 1006, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1010 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1004 and/or the secondary storage. Such computer programs, when executed, enable the exemplary processing system to perform various functions. The main memory 1004, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

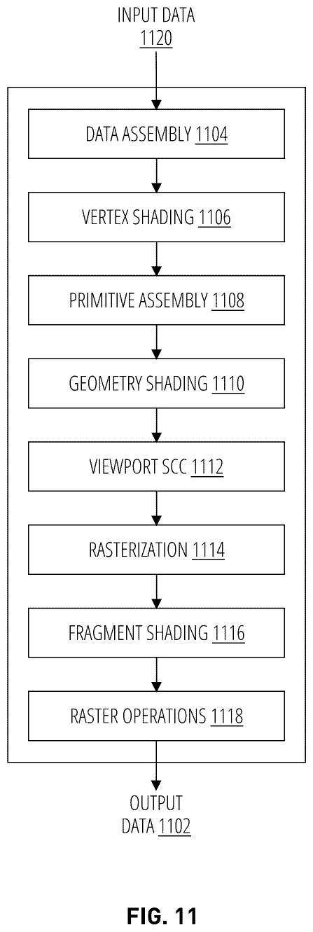

FIG. 11 is a conceptual diagram of a graphics processing pipeline implemented by the parallel processing unit 502 of FIG. 5, in accordance with an embodiment. In an embodiment, the parallel processing unit 502 comprises a graphics processing unit (GPU). The parallel processing unit 502 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 502 can be configured to process the graphics primitives to generate a frame buffer (e.g., pixel data for each of the pixels of the display).

An application writes model data for a scene (e.g., a collection of vertices and attributes) to a memory such as a system memory or memory 524. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 614 modules of the parallel processing unit 502 including one or more of a vertex shader, hull shader, domain shader, geometry shader, and a pixel shader. For example, one or more of the streaming multiprocessor 614 modules may be configured to execute a vertex shader program that processes a number of vertices defined by the model data. In an embodiment, the different streaming multiprocessor 614 modules may be configured to execute different shader programs concurrently. For example, a first subset of streaming multiprocessor 614 modules may be configured to execute a vertex shader program while a second subset of streaming multiprocessor 614 modules may be configured to execute a pixel shader program. The first subset of streaming multiprocessor 614 modules processes vertex data to produce processed vertex data and writes the processed vertex data to the level two cache 704 and/or the memory 524. After the processed vertex data is rasterized (e.g., transformed from three-dimensional data into two-dimensional data in screen space) to produce fragment data, the second subset of streaming multiprocessor 614 modules executes a pixel shader to produce processed fragment data, which is then blended with other processed fragment data and written to the frame buffer in memory 524. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline receives input data 601 that is transmitted from one stage to the next stage of the graphics processing pipeline to generate output data 1102. In an embodiment, the graphics processing pipeline may represent a graphics processing pipeline defined by the OpenGL® API. As an option, the graphics processing pipeline may be implemented in the context of the functionality and architecture of the previous Figures and/or any subsequent Figure(s).

As shown in FIG. 11, the graphics processing pipeline comprises a pipeline architecture that includes a number of stages. The stages include, but are not limited to, a data assembly 1104 stage, a vertex shading 1106 stage, a primitive assembly 1108 stage, a geometry shading 1110 stage, a viewport SCC 1112 stage, a rasterization 1114 stage, a fragment shading 1116 stage, and a raster operations 1118 stage. In an embodiment, the input data 1120 comprises commands that configure the processing units to implement the stages of the graphics processing pipeline and geometric primitives (e.g., points, lines, triangles, quads, triangle strips or fans, etc.) to be processed by the stages. The output data 1102 may comprise pixel data (e.g., color data) that is copied into a frame buffer or other type of surface data structure in a memory.

The data assembly 1104 stage receives the input data 1120 that specifies vertex data for high-order surfaces, primitives, or the like. The data assembly 1104 stage collects the vertex data in a temporary storage or queue, such as by receiving a command from the host processor that includes a pointer to a buffer in memory and reading the vertex data from the buffer. The vertex data is then transmitted to the vertex shading 1106 stage for processing.

The vertex shading 1106 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1106 stage may manipulate individual vertex attributes such as position, color, texture coordinates, and the like. In other words, the vertex shading 1106 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1106 stage generates transformed vertex data that is transmitted to the primitive assembly 1108 stage.

The primitive assembly 1108 stage collects vertices output by the vertex shading 1106 stage and groups the vertices into geometric primitives for processing by the geometry shading 1110 stage. For example, the primitive assembly 1108 stage may be configured to group every three consecutive vertices as a geometric primitive (e.g., a triangle) for transmission to the geometry shading 1110 stage. In some embodiments, specific vertices may be reused for consecutive geometric primitives (e.g., two consecutive triangles in a triangle strip may share two vertices). The primitive assembly 1108 stage transmits geometric primitives (e.g., a collection of associated vertices) to the geometry shading 1110 stage.

The geometry shading 1110 stage processes geometric primitives by performing a set of operations (e.g., a geometry shader or program) on the geometric primitives. Tessellation operations may generate one or more geometric primitives from each geometric primitive. In other words, the geometry shading 1110 stage may subdivide each geometric primitive into a finer mesh of two or more geometric primitives for processing by the rest of the graphics processing pipeline. The geometry shading 1110 stage transmits geometric primitives to the viewport SCC 1112 stage.

In an embodiment, the graphics processing pipeline may operate within a streaming multiprocessor and the vertex shading 1106 stage, the primitive assembly 1108 stage, the geometry shading 1110 stage, the fragment shading 1116 stage, and/or hardware/software associated therewith, may sequentially perform processing operations. Once the sequential processing operations are complete, in an embodiment, the viewport SCC 1112 stage may utilize the data. In an embodiment, primitive data processed by one or more of the stages in the graphics processing pipeline may be written to a cache (e.g. L1 cache, a vertex cache, etc.). In this case, in an embodiment, the viewport SCC 1112 stage may access the data in the cache. In an embodiment, the viewport SCC 1112 stage and the rasterization 1114 stage are implemented as fixed function circuitry.

The viewport SCC 1112 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1114 stage.

The rasterization 1114 stage converts the 3D geometric primitives into 2D fragments (e.g. capable of being utilized for display, etc.). The rasterization 1114 stage may be configured to utilize the vertices of the geometric primitives to setup a set of plane equations from which various attributes can be interpolated. The rasterization 1114 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1114 stage generates fragment data (e.g., interpolated vertex attributes associated with a particular sample location for each covered pixel) that are transmitted to the fragment shading 1116 stage.

The fragment shading 1116 stage processes fragment data by performing a set of operations (e.g., a fragment shader or a program) on each of the fragments. The fragment shading 1116 stage may generate pixel data (e.g., color values) for the fragment such as by performing lighting operations or sampling texture maps using interpolated texture coordinates for the fragment. The fragment shading 1116 stage generates pixel data that is transmitted to the raster operations 1118 stage.

The raster operations 1118 stage may perform various operations on the pixel data such as performing alpha tests, stencil tests, and blending the pixel data with other pixel data corresponding to other fragments associated with the pixel. When the raster operations 1118 stage has finished processing the pixel data (e.g., the output data 1102), the pixel data may be written to a render target such as a frame buffer, a color buffer, or the like.

It will be appreciated that one or more additional stages may be included in the graphics processing pipeline in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1110 stage). Other types of graphics processing pipelines are contemplated as being within the scope of the present disclosure. Furthermore, any of the stages of the graphics processing pipeline may be implemented by one or more dedicated hardware units within a graphics processor such as parallel processing unit 502. Other stages of the graphics processing pipeline may be implemented by programmable hardware units such as the streaming multiprocessor 614 of the parallel processing unit 502.

The graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 502. The API provides an abstraction for a programmer that lets a programmer utilize specialized graphics hardware, such as the parallel processing unit 502, to generate the graphical data without requiring the programmer to utilize the specific instruction set for the parallel processing unit 502. The application may include an API call that is routed to the device driver for the parallel processing unit 502. The device driver interprets the API call and performs various operations to respond to the API call. In some instances, the device driver may perform operations by executing instructions on the CPU. In other instances, the device driver may perform operations, at least in part, by launching operations on the parallel processing unit 502 utilizing an input/output interface between the CPU and the parallel processing unit 502. In an embodiment, the device driver is configured to implement the graphics processing pipeline utilizing the hardware of the parallel processing unit 502.

Various programs may be executed within the parallel processing unit 502 in order to implement the various stages of the graphics processing pipeline. For example, the device driver may launch a kernel on the parallel processing unit 502 to perform the vertex shading 1106 stage on one streaming multiprocessor 614 (or multiple streaming multiprocessor 614 modules). The device driver (or the initial kernel executed by the parallel processing unit 502) may also launch other kernels on the parallel processing unit 502 to perform other stages of the graphics processing pipeline, such as the geometry shading 1110 stage and the fragment shading 1116 stage. In addition, some of the stages of the graphics processing pipeline may be implemented on fixed unit hardware such as a rasterizer or a data assembler implemented within the parallel processing unit 502. It will be appreciated that results from one kernel may be processed by one or more intervening fixed function hardware units before being processed by a subsequent kernel on a streaming multiprocessor 614.

### LISTING OF DRAWING ELEMENTS

102 Gaussian
104 Gaussian initializer
106 camera
108 projector
110 rasterizer
112 scene image
114 density adaptor
402 3D Gaussian
502 parallel processing unit
504 I/O unit
506 front-end unit
508 scheduler unit
510 work distribution unit
512 hub
514 crossbar
516 general processing cluster
518 memory partition unit
520 NVLink
522 interconnect
524 memory
602 pipeline manager
604 pre-raster operations unit
606 raster engine
608 work distribution crossbar
610 memory management unit
612 data processing cluster
614 streaming multiprocessor
616 primitive engine
618 M-pipe controller
702 raster operations unit
704 level two cache
706 memory interface
802 instruction cache
804 scheduler unit
806 register file
808 core
810 special function unit
812 load/store unit
814 interconnect network
816 shared memory/L1 cache
818 dispatch
902 central processing unit
904 switch
906 parallel processing module
1002 communications bus
1004 main memory
1006 input devices
1008 display devices
1010 network interface
1102 output data
1104 data assembly
1106 vertex shading
1108 primitive assembly
1110 geometry shading
1112 viewport SCC
1114 rasterization
1116 fragment shading
1118 raster operations
1120 input data

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A three-dimensional Gaussian splatting (3DGS) system comprising:
a three-dimensional (3D) Gaussian distribution generator; and
an inverse camera projector configured to un-project pixels from image planes to 3D Gaussians in camera space at expected un-projected ray depth positions.

2. The system of claim 1, wherein a 3D Gaussian distribution for pixels that are un-projected from the image plane to camera space comprises an exponential distributed as a function of t*r_{d}−μ′, where t* represents pixel depths on the image plane with ray direction r_{d} from a camera position, and μ′ is a center point of the 3D Gaussian distribution in camera space.

3. The system of claim 2, wherein the ray direction is determined by multiplying pixel coordinates and a camera intrinsic parameter.

4. The system of claim 2, wherein the pixel depths t* on the image plane are determined as a function of μ′, r_{d}, and a camera space covariance matrix Σ′ for the 3D Gaussian.

5. The system of claim 1, configured to apply gradient descent to configure camera space center points for the 3D Gaussians, based on a distribution of the 3D Gaussians in a camera space at expected un-projected ray depth positions.

6. The system of claim 1, configured to apply gradient descent to configure camera space covariant matrices for the 3D Gaussians.

7. The system of claim 1, configured to filter out 3D Gaussians smaller than pixel sizes according to a variance of an applied low-pass kernel.

8. The system of claim 7, wherein a strength of the low-pass kernel is configured to vary for different ones of the 3D Gaussians under different views based on a z-depth of each 3D Gaussian from a camera position and a camera focal length.

9. The system of claim 7, further comprising a training objective configured to regularize the 3D Gaussians to a similar appearance before and after the low-pass kernel is applied.

10. The system of claim 1, further configured with a maximum blending weight to measure the contribution of each 3D Gaussian to training views.

11. The system of claim 10, further configured to prune 3D Gaussians for which the contribution to the training views fails to satisfy a configured threshold.

12. The system of claim 1, further configured to duplicate 3D Gaussians comprising a densification priority satisfying a configured threshold.

13. The system of claim 12, further configured to duplicate a top number of the 3D Gaussians having the highest densification priority.

14. A process comprising:
initializing a set of 3D Gaussian distributions;
un-projecting pixels from two-dimensional planes in an image space to expected depth positions on the 3D Gaussian distributions in a camera space; and
rendering an image comprising the pixels based on evaluating the 3D Gaussian distributions at the expected un-projected depth positions.

15. A computer system comprising:
at least one data processor; and
a memory configured with instructions that, when applied to the at least one data processor, configure the computer system to:
un-project pixels from two-dimensional planes in an image space to expected depth positions on a plurality of 3D Gaussian distributions in a camera space; and
render the pixels based on characteristics of the 3D Gaussian distributions at the expected un-projected depth positions.

16. The computer system of claim 15, wherein the data processor is a graphics processing unit.

17. The computer system of claim 15, the memory further configured with instructions that, when applied to the at least one data processor, configure the computer system to apply gradient descent to configure camera space center points for the 3D Gaussians, based on a distribution of the 3D Gaussians in a camera space at the expected un-projected ray depth positions.

18. The computer system of claim 15, the memory further configured with instructions that, when applied to the at least one data processor, configure the computer system to filter out 3D Gaussians smaller than pixel sizes according to a variance of an applied low-pass kernel.

19. The computer system of claim 18, the memory further configured with instructions that, when applied to the at least one data processor, configure the computer system to configure a strength of the low-pass kernel to vary for different ones of the 3D Gaussians under different views based on a z-depth of each 3D Gaussian from a camera position and a camera focal length.

20. The computer system of claim 15, further configured to prune 3D Gaussians for which a contribution to training views fails to satisfy a configured threshold.
